(19) United States
(12) Patent Application Publication
(10) Pub. No.: US 2006/0060326 A1
(43) Pub. Date: Mar. 23, 2006

(54) Installation for transferring thermal energy

(76) Inventors: Horst Halfmann, Soest (DE); Erhard Eickhoff, Wilstedt (DE)

Correspondence Address: LAURENCE P. COLTON, 1201 WEST PEACHTREE STREET, NW, 14TH FLOOR, ATLANTA, GA, 30309-3488, US

(21) Appl. No.: 11/175,082

(22) Filed: Jul. 5, 2005

(30) Foreign Application Priority Data
Sep. 22, 2004 (DE) 20 2004 014 875.7

(51) Int. Cl. B60H 1/00

(52) U.S. Cl. 165/11.1; 165/63

(57) ABSTRACT

An installation for transferring thermal energy from a first flowing medium to a second flowing medium, or vice versa. The installation comprises a first heat exchanger (10), a second heat exchanger (11) and a compression refrigerator (12), it being possible to exchange thermal energy in the first heat exchanger (10) between the first flowing medium and a coolant of the compression refrigerator (12) and to exchange thermal energy in the second heat exchanger (11) between the coolant and the second flowing medium, with the result that one of the two flowing mediums can be cooled and the other can be heated.

### STATEMENT OF RELATED APPLICATIONS

This patent application is based on and claims convention priority on German utility patent application number 20 2004 014 875.7, having a filing date of 22 Sep. 2004.

### BACKGROUND OF THE INVENTION

1. Technical Field

The invention relates to an installation for transferring thermal energy from a first flowing medium to a second flowing medium, or vice versa.

2. Prior Art

Cooling systems based on compression refrigerators are known. One of their applications is the use of air conditioners. Another application relates to the cooling of machines, assemblies or other heat-generating units. All of these cases involve the application of cooling action, with the dissipated heat being transferred by means of one flowing medium to another medium.

Also known is the process of warming or heating in conjunction with a heat pump, with heat being drawn from one medium and transferred to another medium. Heat pumps also operate on the principle of the compression refrigerator, but, from the user's point of view, heat is supplied instead of removed. In each case of these cited applications or similar applications, an installation is provided for transferring thermal energy from a first medium to a second medium. This installation is dedicated solely to the purpose of the overall system, which means that an installation for transferring thermal energy cannot be utilized for different applications and is therefore usually manufactured in correspondingly small quantities.

### BRIEF SUMMARY OF THE INVENTION

The installation according to the invention for the purpose of transferring thermal energy is meant to fulfill as diverse a range of applications as possible and is thus capable of being produced in larger quantities.

The installation according to the invention for transferring thermal energy from a first flowing medium to a second flowing medium, or vice versa, comprises a first heat exchanger, a second heat exchanger and a compression refrigerator, wherein thermal energy is exchanged in the first heat exchanger between the first flowing medium and a coolant of the compression refrigerator, and in the second heat exchanger between the coolant and the second flowing medium, with the result that one of the two flowing media can be cooled while the other can be heated. The concept of the compression refrigerator also encompasses its function as a heat pump. The function and the individual components of the compression refrigerator are basically known and require no further explanation here. The coolant can also be designated as a heat conveying medium: the coolant merely dissipates or supplies heat. The installation according to the invention can be employed as part of a heating system as well as an air conditioner.

Provided in accordance with another idea of the invention is that the second flowing medium can be taken from an external supply, fed to the second heat exchanger and transferred back to the external supply or to another reserve, it being possible for the second flowing medium to be pumped by a pump through the second heat exchanger, and that a non-return valve is provided between the pump and the second heat exchanger. The second flowing medium is preferably part of an open system. This is the case, for example, if the installation according to the invention is arranged on board a ship and the second flowing medium is taken continuously from the water surrounding the ship and then returned to it. The non-return valve prevents a reflux of the medium when the pump comes to a standstill. The non-return valve is correspondingly designed and connected to ensure that a reflux of the medium automatically results in a closed position of the non-return valve when the pump is shut down.

According to a further idea of the invention, a self-priming pump is provided parallel to the non-return valve between the pump and the second heat exchanger. Under unfavorable circumstances, the inlet side of the first pump can conduct air. Depending on the construction of the pump, this may result in a cessation of medium transport. In order to ensure a smooth and automatic start-up, the self-priming pump is arranged parallel to the non-return valve. The self-priming pump sucks the medium and any air that is present through the first pump, with the result that the first pump for its part will intake fluid and pump it under full pressure into the non-return valve. The first pump is preferably not a self-priming pump, such as a rotary pump, while the self-priming pump has a lower output and is a diaphragm pump, which has a lower output and a smaller cross-section than the first pump.

According to a further idea of the invention, the non-return valve has a floater and a floater detector. The floater detector registers the position of the floater and generates the appropriate signal. In the most simple case, the floater detector detects, on one hand, a maximum open position and, on the other hand, a position of the floater which deviates from the maximum open position in the direction of a closed position. For example, the floater is provided with a magnet while the floater detector is configured as a Reed contact. The maximum open position of the floater is achieved as soon as the pump delivers the second flowing medium through the non-return valve. At this point the magnet reaches its smallest distance to the Reed contact.

Deviations from the maximum open position of the floater arise automatically inasmuch as air bubbles are present in the system. In that case, the floater moves in the direction of the closed position either by its own weight or by spring pressure. This deviation from the maximum open position can be registered by the floater detector, or Reed contact, and used to control the installation or components thereof, e.g. for the purpose of activating the self-priming pump. Preferably, the self-priming pump and/or the first pump can be switched upon receiving a signal from the floater detector.

According to a further idea of the invention, the non-return valve is assigned a pressure sensor. A signal from the pressure sensor can be used to activate the self-priming pump, for example. At the same time, the pressure sensor can also be configured as a pressure switch. The pressure sensor, or pressure switch, is a redundant component with respect to the function of the floater detector. This ensures the operation of the installation. The pressure sensor can also be arranged at a greater distance from the non-return valve somewhere between the non-return valve and the second heat exchanger.

According to a further idea of the invention, the first flowing medium can be pumped by a pump through the first heat exchanger and an air conditioning unit, heating installation or a combined air-conditioning/heating installation, with a non-return valve being provided between the pump and the first heat exchanger. The non-return valve is arranged and connected such that a reflux of the first flowing medium is prevented when the pump is shut down. Under unfavorable circumstances, a thermal reflux may occur in the air conditioner, heating installation or combined air conditioner/heating installation.

The non-return valve preferably has a floater and floater detector for the first flowing medium. The advantages and further characteristics of this measure have already been discussed in connection with the non-return valve for the second flowing medium. In contrast to the non-return valve for the second flowing medium, here (in the loop of the first flowing medium) preferably no self-priming pump is provided. The signal of the floater detector serves in particular for activating the display of a fall in pressure and/or for activating the pump for the first flowing medium. For example, the pump can be turned off for the first flowing medium when the floater detector registers the absence of the maximum open position, if necessary also with a time delay.

Analogous to the above examples, the non-return valve for the first flowing medium can also be assigned a pressure sensor, which can also be arranged at a distance from the non-return valve.

According to a further idea of the invention, a connection is provided for venting the flowing medium or for filling the installation with the flowing medium and is arranged between the pump for the first flowing medium and the associated non-return valve. Preferably, the circuit is filled with the first flowing medium via the connection between the non-return valve and the first heat exchanger. The installation is then vented by using the connection between the pump and the non-return valve. The latter connection is arranged as close to the non-return valve as possible in order to reduce the available space for any remaining air between the non-return valve and connection. The filling operation can be conducted manually, for example, by connecting and opening a water line subject to a signal from the floater detector and/or the pressure sensor.

According to a further idea of the invention, the compression refrigerator is reversible, meaning that one of the two media can be optionally cooled or heated. Depending on the choice of the user, an installation with such a configuration can be switched from cooling to heating or vice versa.

According to a further idea of the invention, at least one of the heat exchangers is at the same time an accumulator for heat or cold. Here the volume available to the first or second medium in the first or second heat exchanger is a multiple, in particular a factor of 20 or greater, of the volume available in the same heat exchanger for the coolant. In this embodiment of the heat exchanger, an otherwise necessary or conventional accumulator is integrated in the design by the larger dimension of the aforementioned volume. This cuts down on additional parts, in particular the otherwise necessary piping. Preferably, the volume available in the heat exchanger is at least 50 to 100 times greater than the volume available for the coolant, in particular approximately 200 times greater.

According to a further idea of the invention, at least one of the heat exchangers has at the same time a pressure compensation volume that is separated from the volume of the first or second medium by an equalization diaphragm. Because of this measure, the otherwise conventional, supplementary pressure compensation container is not required. Also advantageous is a combination of this measure with the volume size described in the previous paragraph, i.e. a volume for each flowing medium that is at least 20 times greater than volume of the coolant.

According to a further idea of the invention, at least one of the heat exchangers has at the same time a volume for an additional flowing medium. While the hitherto described embodiments provide for an exchange of thermal energy in the heat exchanger between a flowing medium and the coolant, here an exchange is possible with a further flowing medium as an alternative or additional possibility. For instance, the second heat exchanger is configured as a container with an inlet and outlet for the first flowing medium. Arranged in the container is a pipe coil for the coolant, also with an inlet and outlet (formed by the container walls). In addition, a further pipe coil, which is also arranged in the container as additional volume for a further flowing medium, has an inlet and outlet guided by the container walls. The preferred applications for such an embodiment are those in which thermal energy is exchanged between the pipe coil for the coolant, on one hand, and the first flowing medium in the container, on the other hand, in order to provide an intermittent alternative or additional exchange of thermal energy between the coolant and the additional flowing medium and/or between the additional flowing medium and the first flowing medium.

According to a further idea of the invention, at least one of the heat exchangers is assigned a pump for the movement of the respective flowing medium, it being possible to conduct the flowing medium in the circuit through the pump and the heat exchanger in a bypass line. This makes it possible to keep the thermal energy in the flowing medium, to keep it in circulation, so to speak, thereby limiting the heat exchange processes to the unavoidable thermal losses in the lines.

A further idea of the invention provides that the second medium can be taken from an external supply store, fed to the second heat exchanger and transferred back to an external supply store or to another storage site, it being possible to pump the second medium through the second heat exchanger with a pump and that at least one filter is provided between the second heat exchanger and the supply stores in order to prevent contamination of the second heat exchanger, and that the pump is reversible in order to backwash the filters or filter. The supply store for the second medium is seawater, for example, which is continuously pumped on board a ship, pumped through the heat exchanger where it is heated, and then returned to the sea. Also conceivable is the removal and/or return process in connection with a large tank.

In an advantageous manner, the first medium can be pumped by a pump through the first heat exchanger, with the thermal energy (heat or cold) of the first medium being provided for the purpose of heating in a heating installation or cooling in an air conditioner, or for both in a combined cooling/heating installation. One important field of application for the invention is its use in mobile or stationary air conditioners, such as those on board ships, in particular those which use seawater as the coolant.

Advantageously, the first heat exchanger is provided with a chiller for cooling and/or heating a space or an area, it being possible to mount the chiller on a wall or to recess it into the wall. It is also possible to recess it only partially. In a chiller, thermal energy is usually exchanged between the flowing medium (water) and the ambient air guided through the chiller. Depending on the temperature difference between the flowing medium and the air, the chiller can be operated as a cooling system (air conditioner) or as a heating system.

Furthermore, it is also possible to provide the chiller with its own heat exchanger for exchanging heat between the first flowing medium and air, with at least one fan for conducting a flow of air through its own heat exchanger, and that the heat exchanger and fan are essentially arranged in a common plane while assuming an inclined orientation such that an air outlet side of the heat exchanger and an air inlet side of the fan form an angle no greater than 170°. Preferably, this angle is greater than 90°, in particular being approximately 130°. By virtue of the described arrangement, the chiller can assume a very flat configuration, thus requiring very little wall space. The chiller can also be counter-sunk into the wall with very little effort.

In an advantageous development, a plurality of fans is provided, namely in a row along one side of the heat exchanger. This measure also ensures a space-saving, flat design of the chiller.

Further features of the invention are presented in the claims and the remaining description. All features can be regarded as being independent of one another. In particular, this applies to the design of the chiller and the heat exchanger.

### BRIEF SUMMARY OF THE DRAWINGS

In the following, advantageous exemplary embodiments of the invention will be presented in more detail on the basis of drawings, which show:

FIG. 1 is a schematic diagram of an installation according to the invention.

FIG. 2 is a schematic diagram of an enlarged installation with respect to FIG. 1.

FIG. 3 is cross-section through a chiller in conjunction with the installation according to the invention.

FIG. 4 is a top view of the chiller pursuant to FIG. 3.

FIG. 5 is a cross-section of another embodiment of the chiller.

FIG. 6 is a top view of the chiller pursuant to FIG. 5.

FIG. 7 is a schematic diagram of a heat exchanger employed in the installation according to the invention.

FIG. 8 is a schematic diagram of another installation according to the invention.

FIG. 9 is a longitudinal section through a non-return valve.

FIG. 9a is a side view of the non-return valve pursuant to FIG. 9 representing the sectional plane of FIG. 9.

### DETAILED DESCRIPTION OF THE PREFERRED EMBODIMENTS

One of the invention's many possible examples of application relates to its use as an air conditioner on board ships in conjunction with seawater cooling. Although the term seawater is used here, this does not exclude the use of fresh water from inland bodies of water.

In the installation a first heat exchanger 10 is coupled to a second heat exchanger 11 by means of a compression refrigerator 12. The latter can have a reversible configuration in order to achieve the option of transporting thermal energy in either direction. Arranged in each of the heat exchangers 10, 11 is a coolant coil 13, 14 which is connected to the compression refrigerator. A coolant is conveyed from the compression refrigerator 12 to the first heat exchanger 10 and back, or to a second heat exchanger 11 and back. In the process, there is a transfer of either heat from the first heat exchanger 10 to the second heat exchanger 11, or vice versa. A corresponding line 15 between the refrigerator 12 and the coolant coil 13 or the second heat exchanger 11 has a temperature sensor 16.

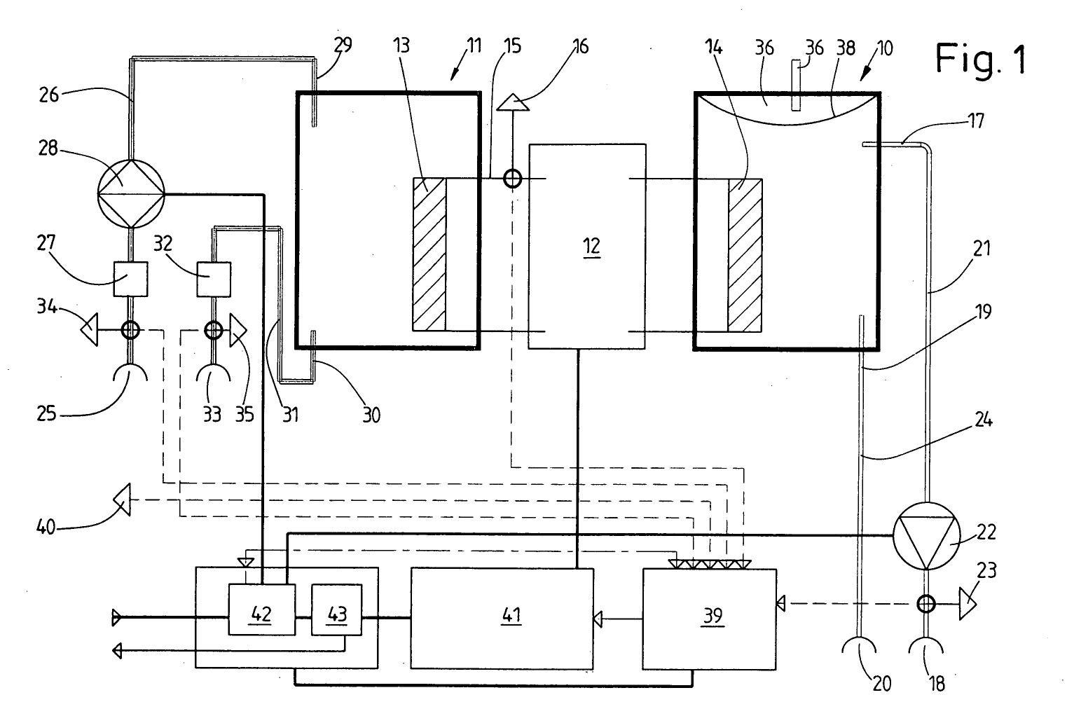

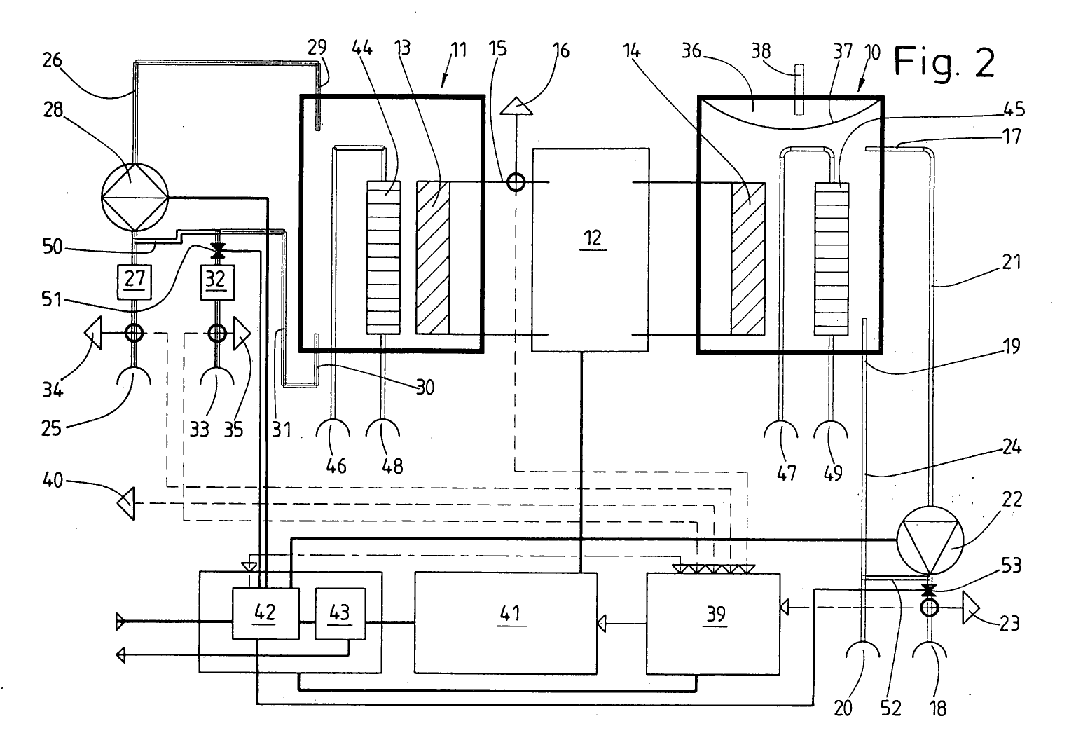

The first heat exchanger 10 is connected to an air conditioner (not shown in FIGS. 1 and 2) by means of a water outlet 17 with a connection 18 for the air conditioner and a water return 19 with a connection 20. Provided in a line 21 between the water outlet 17 and the connection 18 is a pump 22 with a downstream temperature sensor 23. A line between the water return 19 and the connection 20 is labeled with the number 24. In the first heat exchanger 10, heat is removed from the water circulated by the pump 22, with the water then being fed by the compression refrigerator 12 to the second heat exchanger 11. As a result, cooled water is provided at the connection 18 for use in the air conditioner.

The second heat exchanger 11, or more precisely, the coolant coil 13, now contains a heated coolant. This heat is dissipated from the second heat exchanger 11 by means of seawater cooling. For this purpose, fresh seawater is conducted from a suction intake 25, through a line 26 with a filter 27 and pump 28, and delivered through a water inlet 29 to the second heat exchanger 11. The second heat exchanger 11 also has a water outlet 30, from which the heated seawater is conducted through a line 31 with a filter 32 to an outlet port 33. Arranged between the filter 27 and the suction intake 25, and between the filter 32 and the outlet port 33, is a temperature sensor 34, 35 in each case.

The pump 38 is reversible for the purpose of cleaning the filter 27. The filter 32 prevents dirt from entering the second heat exchanger 11, which is cleaned in the subsequent course of normal operation.

The two heat exchangers 10, 11 have a special configuration with a volume for the water flowing in through the water line 29 or the water return 19 which is relatively large with respect to the volume of the coolant coils 13, 14, having an approximate ratio of 200 to 1. This eliminates the need of additional storage tanks for the heat exchangers 10, 11. Instead, the storage function is assumed by the heat exchangers.

Since the second heat exchanger 11 is connected to a source of seawater, it is part of an open circuit. For that reason, no appreciable fluctuations in pressure or temperature are to be expected.

The situation presented in the region of the first heat exchanger 10 is somewhat different. The connected air conditioner results in a preferably closed circuit. In order to avoid excess pressure and to compensate for any fluctuations in temperature that may arise, the first heat exchanger 10 has a pressure compensation volume 36, which is separated from the rest of the inner space of the heat exchanger 10 by an equalization diaphragm 37. The equalization diaphragm 37 is elastically flexible. In order to generate a defined counterpressure in the pressure compensation volume 36, air or another gas can be either supplied to or discharged from it through a valve 38.

The control system for the installation is provided by a microprocessor control 39. It is capable of receiving signals, including those initialized by the individual sensors 16, 23, 34, 35 and by an outside temperature sensor 40, and regulates the operation of the installation's individual components as a function of these signals and in accordance with instructions provided by the user.

The control system addresses, among other elements, a frequency converter 41 which feeds the compression refrigerator 12, and a pump reversing control 42 for the seawater pump 28. The pump 22 is also actuated by this control 42. A dc power supply 43, in particular one operating on 24 volts, is provided between the pump reversing control 42 and the frequency converter 41.

The installation shown in FIG. 2 exhibits additional features with respect to the installation pursuant to FIG. 1:

Provided in the two heat exchangers 10, 11 are additional exchanger coils 13, 14. In the present case, the exchanger coils 44, 45 are provided to heat the service water on board the ship used for showers, dishwashing, heating and the like. The consumer units each connected to the water inlets 46, 47 and water outlets 48, 49 are not illustrated, nor are the additional means for controlling the water circuit through the exchanger coils 44, 45. In place of the cited consumer units which require warm water, it is also possible to service consumer units that require cold water, such as motor cooling systems, in particular as connected to the exchanger coil 45 on the side of the first heat exchanger 10.

As described above, the coolant coil 13 is provided with thermal energy by the heated coolant. But instead of dissipating this heat into the seawater, it is possible here to transfer it to the water in the exchanger coil 44. The transfer is supported by maintaining the flow of seawater into the second heat exchanger 11 (water inlet 29) and out of the heat exchanger (water outlet 30). In order to prevent heat from dissipating into the seawater via the outlet port 33, a bypass line 50 is provided which is connected to the line 26 between the pump 28 and filter 27 and which is also connected to the line 31 to bypass the filter 32. A valve 51 closes the line 31 directly before the filter 32 whenever necessary, thus generating a water circuit via the bypass line 50.

In analogous fashion, a short circuit of the first flowing medium can be achieved for the first heat exchanger 10 through the lines 21 and 24. Provided immediately behind the pump 22 in the direction of flow is a bypass line 52 which connects the lines 21 and 24. When a valve 53 provided between the connection 18 and the pump 22 is closed, the water flows in the short circuit via the bypass line 52. The makes it possible to achieve an optimum heat exchange between the coolant coil 14 and the exchanger coil 44 without incurring the loss of energy through an air conditioner attached to the connections 18, 20 or through another consumer.

The valves 51, 53 can be actuated electrically, for example by means of the pump reversing control 42, whose range of functions has been appropriately expanded. The refrigerator machine 12 is preferably turned off when the flowing media circulate in the bypass circuit.

A special function is assumed by the temperature sensor 16 in the coolant circuit. Connected to it is a rapid shut-down device activated whenever defined temperatures are exceeded. Analogously, switching operations, in particular shut-down operations, can be made in response to signals provided by the other sensors.

Valves, in particular so-called seawater valves, which can be actuated either manually or electrically, can be provided in the region of the suction intake 25 and the outlet port 33.

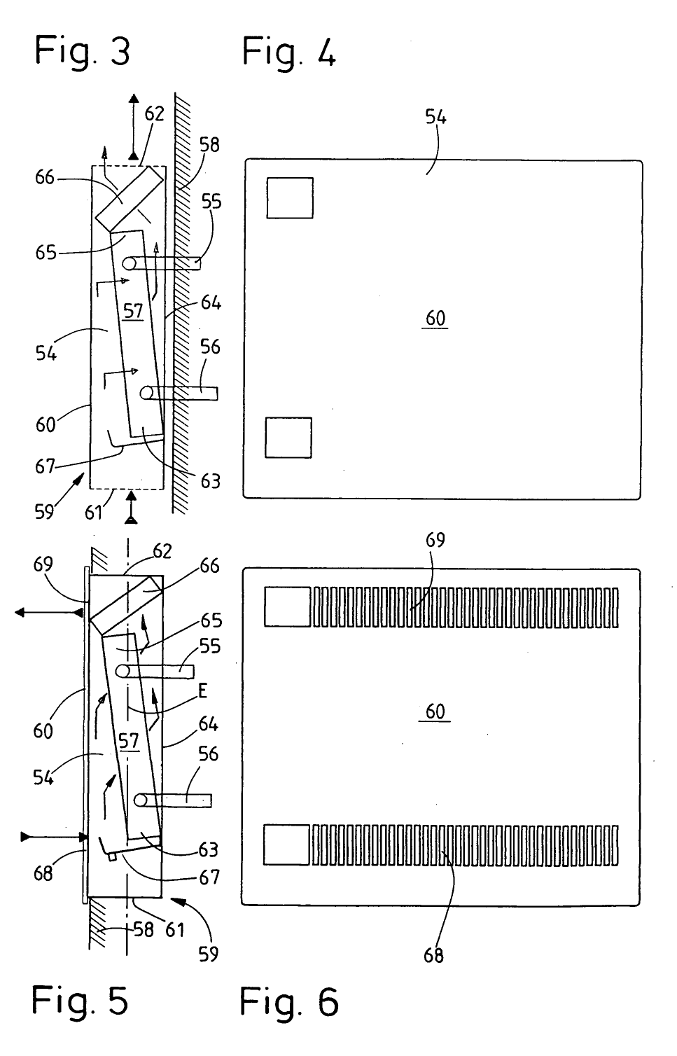

FIGS. 3 to 6 show the design and configuration of a chiller in two variants. FIGS. 3 and 4 relate to a wall-mounted chiller 54. This has a supply 55 and a return 56, which are connected to a heat exchanger 57 inside the chiller and which lead through a wall 58 to the connections 18, 20 (FIGS. 1 and 2).

A housing 59 of the chiller 54, having a cuboid shape and a flat configuration, projects only slightly from the wall 58. The likewise flat heat exchanger 57 is mounted behind a large-surface front wall 60. In contrast to the other walls, bottom wall 61 and top wall 62 are designed to be air-transmissible, making it possible for an upward-flowing stream of air to pass through the housing 59.

The heat exchanger 57 is arranged in the housing 59 at an angle such that a lower edge 63 of the heat exchanger 57 abuts a rear wall 64, while a top edge 65 is situated at a very close distance to the front wall 60 or even abuts the latter.

Arranged above the heat exchanger 57 is a row of fans 66, with the row extending in a direction transverse to the image plane. The individual fans 66 are mounted at a tilt, resulting in an approximately 130° angle between the fans (plane of the fans) and the heat exchanger 57.

The air inflowing through the bottom wall 61 in FIG. 3 travels through the heat exchanger 57 from left to right, giving off heat to the cold water fed to the heat exchanger, flows upwards through the fans 66 and finally exits the housing 59 of the chiller 54 through its top wall 62.

Arranged below the heat exchanger 57 is a condensation pan 67 which is attached to the rear wall 64 and which collects precipitated condensation.

FIGS. 5 and 6 show the chiller 54 in a version that is countersunk in the wall. The housing 59 is countersunk in the wall 58 to a point where the front wall 60 is practically flush with the wall. The arrangement of heat exchanger 57 and fans 66 in the housing 59 matches their arrangement pursuant to FIG. 3. The only modifications made are those in the housing. Nevertheless, the same reference numbers are used in FIG. 5 as in FIG. 3. The present modifications are explained as follows:

In their embodiment pursuant to FIGS. 5 and 6 bottom wall 61 and top wall 62 have a closed design. The air enters the housing 59 in a lower region of the front wall 60. For this purpose, the front wall has near a lower edge an appropriately wide inlet opening or the shown row 68 of inlet slits. The air flowing out of the fans 66 passes out of the front wall 60 through an appropriately wide outlet opening, or the shown row 69 of outlet slits near an upper edge of the front wall 60. Here, too, fans 66 and heat exchanger 57 assume a tilted arrangement with respect to a plane E of the chiller and with respect to one another.

With only a minimum of modifications in the region of the housing 59, it is possible to mount the chiller 54 on a wall as well as to counter-sink it in the wall.

The chiller 54 can also be used as a heating system. This requires that the corresponding heat be provided. For example, the exchanger coil 45 in the first heat exchanger 10 can be connected to the cooling water of an engine on board a ship.

The described installation can be modified for other purposes. For example, the lines 26, 31 can be connected to an air cooler found in vehicles (campers) or buildings, for example. A non-reversible type of pump may be used instead of the pump 28.

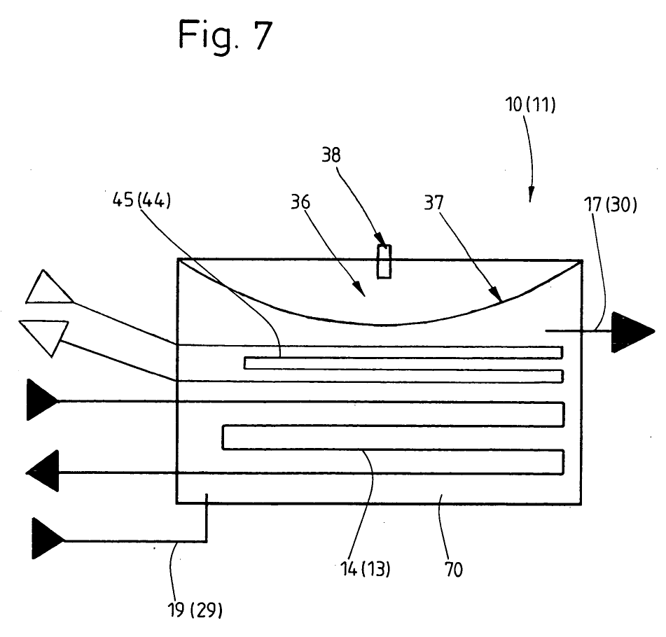

The schematic design of the heat exchangers 10, 11 is shown in FIG. 7. Interactive effects occur between two to four different volumes. In the first place, the volume 70 available for the flowing medium is located in the interior of the heat exchanger. The volume is fed by the flowing medium, which enters the heat exchanger through the return 19 or inlet 29 and exits through the outlet 17 or 30.

A second volume is situated within the coolant coil 14 or 13. This second volume is considerably smaller than the cited first volume 70, having approximately 1/200 of the first volume's capacity. The heat exchangers 10 or 11 therefore function also as a heat accumulator.

In addition, a third volume, namely the pressure compensation volume 36, and/or a fourth volume analogous to the contents of the coolant coils 13, 14 may be provided. The heat exchanger 10 in FIG. 2 contains the exchanger coil 45 as the fourth volume, while the exchanger coil 44 is shown as the third volume in the heat exchanger 11 in FIG. 2. The available volume available in the exchanger coils 44, 45 corresponds approximately to the volume of the coolant coils 13, 14.

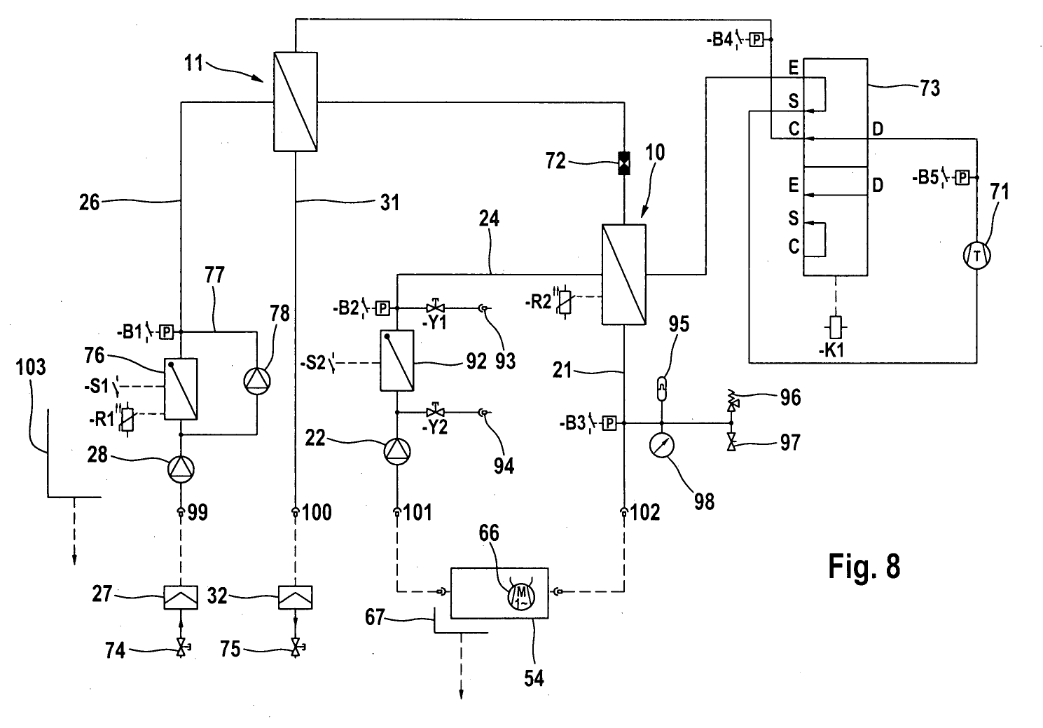

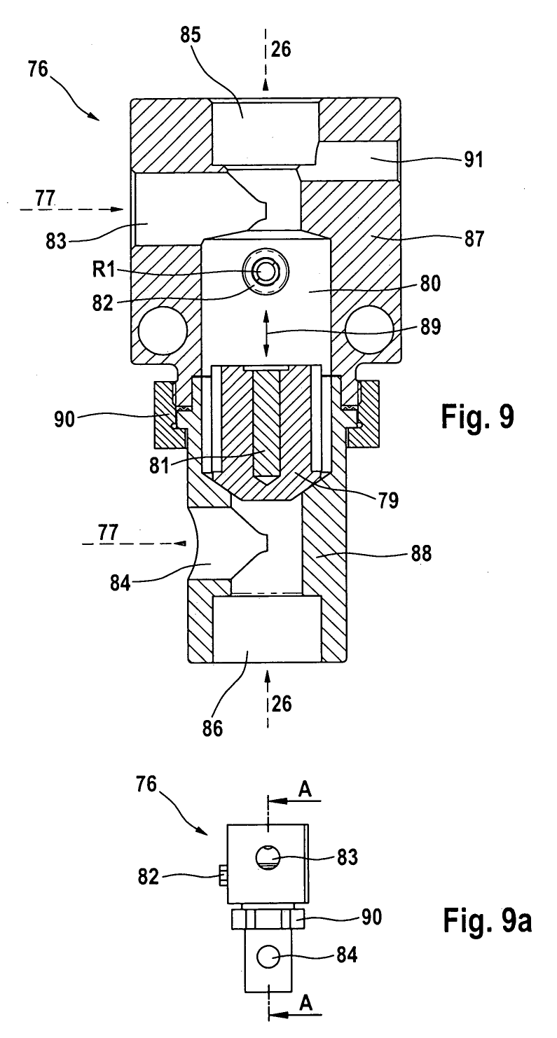

A further embodiment of the invention will be discussed below as shown in FIGS. 8, 9, and 9a.

FIG. 8 shows the design of an installation according to the invention and similar to that shown in FIG. 1. Components acting in the same manner have been labeled with the same reference numbers.

The two heat exchangers 10, 11 are connected to each other in the circuit of a compression refrigerator. The latter is shown with its individual components, namely a compressor 71, a choke 72 and a 4/2 direction control valve 73 provided on the side of the compressor 71. Said direction control valve 73 serves to switch the direction of flow in the circuit between the heat exchangers 10, 11, making it possible to switch arbitrarily between heating and cooling operations. Said components 71, 72, 73 are not shown in the aforementioned figures. Only the compression refrigerator 12 containing said components is shown.

Arranged in each case between compressor 71 and valve 73, on one hand, and between valve 73 and the second heat exchanger 11, on the other hand, is a pressure switch B4, B5. This provides an additional control of the compressor 71 or other elements of the installation.

One side of the second heat exchanger 11 is connected to an open system. For example, if the installation is on board a ship it can serve as air conditioning for cabins. Seawater (fresh water is also possible) flows through the second heat exchanger 11 as the coolant. The coolant is drawn in through a line (not shown) that is connected to a valve 74. Analogously, water heated in the second heat exchanger 11 is released through the valve 75 into a line open to the seawater.

Arranged between the pump 28 and the second heat exchanger 11 in this embodiment is a non-return valve 76. Provided parallel to the non-return valve 76 is a line 77 with a pump 78. The pump 28 is a non-self-priming rotary pump, while the pump 78 is a low-output self-priming pump, such as a diaphragm pump.

In the present embodiment, the liquid in the line 26 is meant to be conveyed in one direction only, namely from the valve 74, through the pump 28, the non-return valve 76 and the second heat exchanger 11 to the valve 75. When the pump 28 is shut down, the non-return valve prevents a reflux of the liquid standing in the line from the valve 74 (e.g. back into the seawater). In this manner it is possible to fill the line 26 with air beneath the non-return valve 76, i.e. in the region of the pump 28. This renders the diaphragm pump 28 ineffective, for although it is economical to produce, it is not a self-priming pump. The transport of the liquid through the second heat exchanger 11 is thereby disrupted.

This situation can be corrected by the self-priming pump 78. It inevitably intakes liquid even if air is present in the region of the pump 28. As a result, the entire line 26 is soon filled with liquid again, with the pump 28 regaining its operability and forcing open the non-return valve 76. The cross-section of the line and pump output is smaller than is the case with the pump 28, which ensures that the non-return valve 76 opens reliably. After the pump 28 starts up, the pump 78 can be turned off again.

The non-return valve 76 is provided with additional sensors, see also FIG. 9. The non-return valve 76 has a floater 79 as its non-return body which can be moved up and down parallel to the direction of flow. Shown in FIG. 9 is the lower position of the floater 79, its closed position.

The floater 79 is provided with a centered magnet 81 arranged parallel to the direction of flow. In an open position (not shown) of the floater 79, the magnet 81 lies in front of a Reed contact 82—designated in FIG. 8 as S1.

When the pump 28 is effectively running, the liquid flow presses the floater 79 into its open position, thus activating the Reed contact 82. As soon as air appears in the non-return valve 76 the floater 79 sinks in the shown closed position. This causes the Reed contact 82 to alter its switched state. Due to this change in the switched state, the operation of the self-priming pump 78 can be initiated and stopped once more. The pump 28 can continue to operate parallel to this. The circuit logic can be arranged such that the switching on of the pump 78 requires that the pump 28 is already activated. A temporary idling of the pump 28, for example if air has entered the system, thus causes no damage. The pump 78 rapidly removes the air present in the system and ensures that the line 26 is completely filled with liquid.

FIG. 9 shows the connection ports 83, 83 in the line 77 which are arranged transverse to the direction of flow (and thus transverse to the direction of floater movement). Provided concentrically to the floater's direction of movement are connection ports 85, 86 for the line 26. These have a significantly larger cross-section than the connection ports 83, 84.

The non-return valve 76 is provided with a two-part housing. The two housing parts 87, 88 close together in the floater's direction of movement (arrow 89) and are connected to each other by means of a swivel nut 90. The housing of the non-return valve 76 is divided such that the floater chamber is also divided, with the result that the floater 79 in its closed position is situated in the lower valve housing part 88 and in its open position it is situated in the upper valve housing part 87. The lower valve housing part 88 is associated with the connection ports 84 and 86, while the two other connection ports 83 and 85 are assigned to the upper valve housing part 87.

Here the non-return valve 76 exhibits two further special features. For one, a temperature sensor R1 is provided in the valve as indicated in FIG. 8 as well. Its signal can be used to control the installation. The sensor R1 is seated in the Reed contact 82.

Furthermore, a pressure switch B1 is provided at the connection port 85 proceeding from second heat exchanger 11. Shown in FIG. 9 is a bore hole 91 opposite the connection port 83 for accommodating the pressure switch B1. The function of the pressure switch B1 is preferably redundant with respect to the function of the Reed contact 82, and thus represents a safety element. In the case of a pressure drop to approximately 1 bar or less, it is assumed that air has entered the system and that the pump 28 is not completely effective. Proper functioning of the installation is only assumed at a higher pressure reading, thus avoiding the need to activate the pump 78. Preferably the pressure limit set for the pressure switch B1 is greater than the pressure generated by the pump 78.

The chiller 54 is connected to the first heat exchanger 10 in a closed circuit. Arranged in the return flow, i.e. between the chiller 54 and the first heat exchanger 10 are the pump 22 and a non-return valve 92. The latter has the same configuration as the non-return valve 76 pursuant to FIG. 9, including a Reed switch S2 and pressure switch B2, but without the temperature sensor R1 shown in FIG. 8.

Provided upstream and downstream of the non-return valve 92 are valves Y1 and Y2 having the appropriate connecting pieces 93, 94. If needed, they can be used to fill the closed circuit, in particular with water, when the circuit is filled for the first time, following maintenance work, or when air has entered the system due to some other reason. Water is then supplied through the valve Y1 and connecting piece 93. The inflowing water is prevented by the non-return valve 82 from flowing in the direction of the pump 22 and the chiller 54. The air present in the system is vented by the open valve Y2 and forced out of the connection piece 94.

Here the Reed switch S2 of the non-return valve 92 is used to signal a position of the floater that deviates from the open position. The signal can be coupled to an optical display or acoustic warning to inform the user whenever air is present in the system in the vicinity of the pump 22.

Provided along the line 21 between the first heat exchanger 10 and the chiller 54 is a safety device, comprising a pressure switch B3, a surge tank 95, a safety valve 96 and a quick-vent valve 97. In addition, it is possible to provide a manometer 98.

The direction of flow in the circuit between the chiller 54 and the first heat exchanger 10 is preferably established, namely from the pump 22 through the non-return valve 92 to the first heat exchanger 10 and from there to the chiller 54.

Analogously, the direction of flow in the open system of the second heat exchanger 11 is preferably established, namely from the filter 27 through the pump 28 and non-return valve 76 to the second heat exchanger 11 and from there through the filter 32 to the valve 75. A backwashing is not provided for in the exemplary embodiment pursuant to FIG. 8. Nevertheless, both filters 27, 32 are meant to protect the line system from water inflowing from the outside. For example, when the installation is at a standstill, it is possible for seawater to enter the open system up to filter 32. In the preferred embodiment employed in practice, both filters 27, 32 are arranged such that they can be easily removed from the line system and cleaned.

A compact, contiguous design is preferred for the installation as a whole. As can be seen in FIG. 8, there are four connections 99, 100, 101, 102 signifying points of separation between circuit lines represented by solid and dashed lines. All components above the connections 99 to 102—including the compressor circuit with the components 71, 72, 73—are arranged in a common housing, thus making it easy to deliver and set them up at the installation site. The connections 99 to 102 and the connecting pieces 93, 94 are arranged on a common outer wall of the housing. This arrangement makes it quite easy to connect the chiller 54 with the appropriate lines, for example.

Said housing or the non-return valve 76 itself has a condensation water line 103 that corresponds to the function of the condensed water pan 67 at the chiller 54.

Not shown in FIG. 8 is the electronic control of the installation. It can be dependent on signals of various sensors. Mention has already been made of pressure switches, Reed contacts and switches, and temperature sensors. These also include a temperature sensor R2 at the first heat exchanger 10. The heat exchanger 10 is designed such that a connection between the lines 21, 24 accommodates a thin line running concentrically inside it which is connected to the choke 72 and valve 73. The desired heat transfer takes place during this concentric course between the liquids in the two lines. Located along this heat transfer section is the temperature sensor R2, specifically at a position occurring after approximately 40% to 80% of the heat transfer section as seen from coming from the line 24. When the installation is in the cooling mode, turning off the chiller 54 under unfavorable circumstances may result in icing in the first heat exchanger 10. This can be prevented by the corresponding signals released by the temperature R2 and their evaluation with the appropriate installation control system.

### List of Designations

10 first heat exchanger
11 second heat exchanger
12 compression refrigerator
13 coolant coil
14 coolant coil
15 line
16 temperature sensor
17 water outlet
18 connection
19 water return
20 connection
21 line
22 pump
23 temperature sensor
24 line
25 suction intake
26 line
27 filter
28 pump
29 water inlet
30 water outlet
31 line
32 filter
33 outlet port
34 temperature sensor
35 temperature sensor
36 pressure compensation volume
37 equalization diaphragm
38 valve
39 microprocessor control
outside temperature sensor
41 frequency converter
42 pump reversing control
43 dc power supply
44 exchanger coil
45 exchanger coil
46 water inlet
47 water inlet
48 water outlet
49 water outlet
50 bypass line
51 valve
52 bypass line
53 valve
54 chiller
55 supply
56 return
57 heat exchanger
58 wall
59 housing
60 front wall
61 base wall
62 top wall
63 lower edge
64 rear wall
65 top edge
66 fan
67 condensed water pan
68 row of inlet slits
69 row of outlet slits
70 volume
71 compressor
72 choke
73 4/2 direction control valve
74 valve
75 valve

What is claimed is:

1. An installation for transferring thermal energy from a first flowing medium to a second flowing medium, or vice versa, with a first heat exchanger (10), a second heat exchanger (11) and a compression refrigerator (12), wherein thermal energy is exchanged in the first heat exchanger (10) between the first flowing medium and a coolant of the compression refrigerator (12), and in the second heat exchanger (11) between the coolant and the second flowing medium, with the result that one of the two flowing media is cooled while the other is heated.

2. The installation according to claim 1, wherein the second flowing medium is taken from an external storage supply, fed to the second heat exchanger (11) and transferred back to the external supply to another reserve, wherein the second flowing medium is pumped by a pump (28) through the second heat exchanger (11), and a non-return valve (76) is provided which is arranged between the pump (28) and the second heat exchanger (11).

3. The installation according to claim 2, wherein a self-priming pump (78) is provided parallel to the non-return valve (76) between the pump (28) and the second heat exchanger (11).

4. The installation according to claim 2, wherein the non-return valve (76) has a floater (81) and a floater detector.

5. The installation according to claim 4, wherein the self-priming pump (78) and/or the pump (28) can be switched subject to a signal from the floater detector.

6. The installation according to claim 2, wherein the non-return valve (76) is assigned a pressure sensor (B1).

7. The installation according to claim 1, wherein the first flowing medium is pumped by a pump (22) through the first heat exchanger (10) and an air conditioning unit, heating installation or a combined air-conditioning/heating installation, with a non-return valve (92) being provided between the pump (22) and the first heat exchanger (10).

8. The installation according to claim 7, wherein the non-return valve (92) has a floater and a floater detector.

9. The installation according to claim 8, wherein the pump (22) is switched subject to a signal from the floater detector of the non-return valve (92).

10. The installation according to claim 8, wherein the non-return valve (92) is assigned a pressure sensor (B2).

11. The installation according to claim 8, wherein a connection (94) is provided for venting the flowing medium or for filling the installation with the flowing medium and is arranged between the pump (22) and non-return valve (92), and a connection (93) for filling the installation with the flowing medium or for venting the same is provided between non-return valve (92) and the first heat exchanger (10).

12. The installation according to claim 1, wherein the compression refrigerator (12) is reversible, such that one of the two media can be optionally cooled or heated.

13. The installation according to claim 1, wherein at least one of the heat exchangers (10, 11) is at the same time an accumulator for heat or cold, and that for this purpose the volume (70) available to the first or second medium in the first or second heat exchanger is a multiple of the volume available in the same heat exchanger for the coolant.

14. The installation according to claim 1, wherein that at least one of the heat exchangers (10, 11) has at the same time a volume (exchange coil 44, 45) for an additional flowing medium.

15. The installation according to claim 1, wherein at least one of the heat exchangers (10, 11) is assigned a pump (22, 28) for the movement of the respective first or second flowing medium, wherein at least one of the flowing media in the circuit is conducted through its associated pump and heat exchanger the heat through a bypass line (50, 52) in the circuit via the associated pump.

16. The installation according to claim 1, wherein the second medium is taken from an external supply store, fed to the second heat exchanger (11) and transferred back to an external supply store or to another storage site, wherein the second medium is pumped through the second heat exchanger (11) with a pump (28), at least one filter (27, 32) is provided between the second heat exchanger (11) and the supply store or supply stores in order to prevent contamination of the second heat exchanger (11), and the pump (28) is reversible for backwashing at least one of the filters.

17. The installation according to claim 1, further comprising at least one chiller (54) connected to the first heat exchanger (10) for cooling and/or heating a space or area, wherein the chiller (54) is mounted on a wall (58) or countersunk into the wall (58).

18. The installation according to claim 17, wherein the chiller (54) has its own heat exchanger (57) for exchanging heat between the first flowing medium and air, the chiller (54) has at least one fan or ventilator (66) for conducting a flow of air through the heat exchanger (57), and the heat exchanger (57) and fan are essentially arranged in a common plane while assuming an orientation inclined thereto such that an air outlet side of the heat exchanger (57) and an air inlet side of the fan form an angle that is less than 170°.

19. The installation according to claim 18, wherein a plurality of fans (66) is provided in a row along a side (top edge 65) of the heat exchanger (57).

20. The installation according to claim 13, wherein the multiple is a factor of 20 or greater.
